(19) United States
(12) Patent Application Publication
(10) Pub. No.: US 2011/0197422 A1
(43) Pub. Date: Aug. 18, 2011

(54) CONSTRUCTION METHOD FOR LARGE RADIAL ADSORBERS

(75) Inventors: Christian Monereau, Paris (FR); Pierre Jeannot, Chennevieres sur Marne (FR)

(73) Assignee: L'Air Liquie Societe Anonyme pour l'Etude et Exploitation des Procedes Georges Claude, Paris (FR)

(21) Appl. No.: 13/125,248

(22) PCT Filed: Oct. 12, 2009
(86) PCT No.: PCT/FR2009/051938

§ 371 Date: Apr. 20, 2011

(30) Foreign Application Priority Data
Oct. 21, 2008 (FR) 0857132

(51) Int. Cl. B23P 11/00; B23Q 1/25

(52) U.S. Cl. 29/428; 269/55

(57) ABSTRACT

The invention relates to a method for assembling at least one radial adsorber including at least two concentric perforated grids, an upper base, a lower base, and a cylindrical collar with the same axis as said grids, characterised in that said perforated grids are assembled concentrically on the horizontal plane.

The invention relates to an assembly allowing for the horizontal assembly of radial adsorbers and to the method of horizontally assembling said adsorbers.

Adsorption is widely used to purify or separate gases. Typical processes are the separation of n and iso paraffins, the separation of xylenes, alcohols, the production of nitrogen or oxygen from atmospheric air, CO₂ deballasting of combustion gases, tall furnace gases, etc. On the purification side, there are the dryers, the purification of hydrogen or helium, the purification of methane-rich gas, the adsorption of impurities as traces in numerous fluids (stopping mercury, NOx, sulfurated products, etc.).

The methods that use adsorption are of several types depending on whether the adsorbent can or cannot be regenerated in situ. If not, the expression “adsorption with lost charge” (to be renewed when the product is saturated with impurities) applies, otherwise the expression “adsorption cycles” applies.

The adsorption cycles differ firstly by the manner in which the adsorbent is regenerated.

If the regeneration is done mainly by increasing temperature, it is a TSA (Temperature Swing Adsorption) method. If, however, the regeneration is performed by lowering the pressure, it is a PSA (Pressure Swing Adsorption) method; the expression “PSA method” should be understood to mean the actual PSA methods, that is to say, methods with the adsorption phase which is performed at a pressure substantially higher than atmospheric pressure and the regeneration phase which is performed at a pressure a little above atmospheric pressure, the VSA (Vacuum Swing Adsorption) methods for which the adsorption phase is performed at a pressure of around atmospheric pressure and the regeneration is performed in a vacuum, the VPSA and similar (MPSA, MSA, etc.) methods with an adsorption phase that is performed at a few bars and the regeneration is performed in a vacuum. This category also includes the system that are regenerated by scavenging with a purge gas (or elution gas), that may be external to the method itself. In this case, the partial pressure of the impurities is in fact lowered, which enables them to be desorbed.

Adsorbent is used in reactors which will hereinafter be called adsorbers. These adsorbers are also of different types depending on their geometry.

The simplest adsorber is of cylindrical form with vertical axis. When the flow rate to be purified becomes significant, cylindrical adsorbers with horizontal axis can be used.

Beyond a certain flow rate and/or if small load losses are desired and/or if the speed of the gas may be greater than the attrition speed (speed with which the balls are set in motion) at least in certain steps of the cycle, it becomes advantageous to use a radial adsorber.

For example, when the flow rates to be purified reach a few tens of thousands of real cubic meters (that is to say, counted in operating conditions), it is actually known to use radial adsorbers as taught in the document U.S. Pat. No. 4,541,851 or in document EP 1 638 669.

Radial adsorbers make it possible in fact to reliably carry out the purification or separation of large quantities of fluid by allowing, because of their geometry, a wide freedom of choice for the circulation speeds of said fluids, in particular to make them compatible with the mechanical properties of the adsorbent particles used, while ensuring a good gaseous distribution through the adsorbent masses. This flexibility stems from the fact that the gas passage section is dependent on the diameter and the height of the gratings and not just the diameter as for a standard adsorber. They are therefore used in particular for drying and decarbonating air before it is fractionated by cryogenics, in the case of oxygen VSA, and are particularly well suited to CO₂ VSA or PSA, units that have to handle very high flow rates (several hundreds of thousands of Nm³/h) at low or average pressure (generally lower than 10 bar abs, with regeneration at atmospheric pressure or in a vacuum).

The drying and decarbonation of air will now be taken as an example to describe a TSA cycle implementing such an adsorber so as to illustrate its operation. It is known that atmospheric air contains compounds that have to be eliminated before said air is introduced into the heat exchangers of the cold box of an air separation unit, notably the compounds carbon dioxide (CO₂), steam (H₂O) , nitrogen oxides and/or hydrocarbons for example.

In practice, in the absence of such preprocessing of the air to eliminate its CO₂ and water impurities therefrom, there is a solidification into ice of these impurities during the cooling of the air to cryogenic temperature typically below or equal to −150° C., which may cause equipment clogging problems, notably in heat exchangers, distillation columns, etc.

Furthermore, it is also common practice to at least partially eliminate the hydrocarbon and nitrogen oxide impurities likely to be present in the air in order to avoid too great a concentration in the bottom of the distillation column or columns, and any consequent risk of degradation of the equipment.

Conventionally, an air purifying TSA method cycle comprises the following steps:
a) purification of the air by adsorption of the impurities at above-atmospheric pressure and at ambient temperature,
b) depressurization of the adsorber to atmospheric pressure,
c) regeneration of the adsorbent at atmospheric pressure, notably by the waste gases, typically impure nitrogen originating from an air separation unit and reheated to a temperature usually between 100 and 250° C. by means of one or more heat exchangers,
d) cooling of the adsorbent to ambient temperature, notably by continuing to introduce therein said waste gas obtained from the air separation unit, but not reheated,
c) repressurization of the adsorber with purified air obtained, for example, from another adsorber in the production phase or possibly with the air to be purified.

Generally, the air preprocessing devices comprise two adsorbers, operating alternately, that is to say that one of the adsorbers is in the production phase while the other is in the regeneration phase.

The production phase corresponds to the purification of the gaseous mixture by adsorption of the impurities.

The regeneration phase comprises the depressurization, heating, cooling and repressurization steps.

A step for placing two adsorbers in parallel, which may be a short or long operation, that is to say from a few seconds to several minutes, is generally added at the start or at the end of the regeneration phase.

Such TSA methods are notably described in the documents U.S. Pat. No. 3,738,084 and FR-A-7725845.

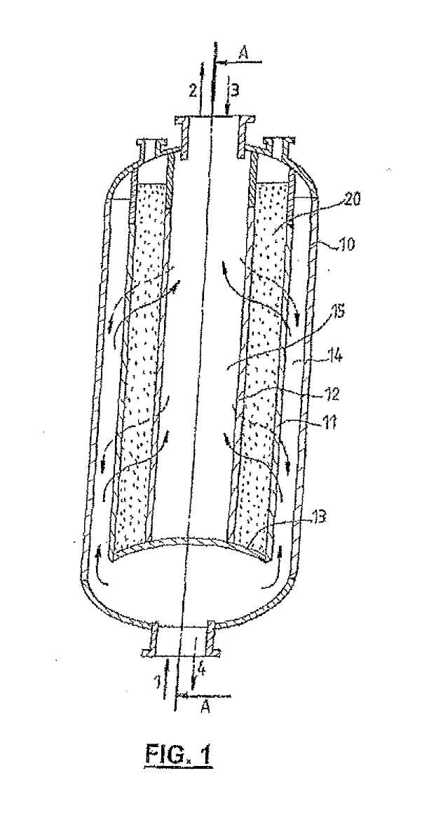

The operation of a radial adsorber for such an application is represented in FIG. 1.

The fluid to be purified or to be separated 1 enters into the lower part of the radial adsorber 10, passes through the adsorbent mass 20 and the purified fluid leaves at the top part 2. During regeneration, the regeneration fluid 3 enters against the flow through the top part, desorbs the impurities contained in the adsorbent mass 20 and the waste gas 4 leaves the bottom part.

The adsorber itself 10 consists of a cylindrical shell with a vertical axis AA and 2 end plates. The adsorbent mass is kept in place by means of an external perforated grating 11 and an internal grating 12, also perforated, which are fixed on one side to the top end plate, and on the other side to a solid plate 13 in the bottom part. The fluid to be purified or separated 1 vertically circulates at the periphery in the external free region 14 between the cylindrical shell and the external grating, passes radially through the adsorbent mass 20 then circulates vertically in the internal free region 15 before leaving the adsorber through the top. The regeneration is done in the reverse direction,

In the above description, the gas to be purified during the adsorption phase circulates from the periphery towards the center, in which case the expression “centripetal circulation in adsorption” applies. The corresponding regeneration is then performed centrifugally, that is to say, from the center to the outside. This is the most usual configuration but the radial adsorbers may be used in the same way with reverse directions of circulation, that is to say, in adsorption mode for example, the gas to be treated will go from the inside to the outside whereas in regeneration mode, the regeneration gas will circulate from the outside to the inside. Another possible arrangement consists in adding the circular sealing disk to divide the adsorbent mass into two parts. It is then possible in one and the same radial adsorber to have, in the adsorption phase for example, a centrifugal circulation in a first adsorbent volume followed by a centripetal circulation in the upper volume of adsorbent.

In practice, the adsorbent material may consist of one and the same adsorbent, for example zeolite X or doped activated alumina, or comprise several beds.

Among the multiple beds, the following pairs may be mentioned (activated alumina; zeolite X), (silica gel; zeolite X), (zeolite X, exchanged zeolite), etc.

It may also be advantageous to use multilayers of the type (water-resistant silica gel; standard silica gel or activated alumina; zeolite X) or of the type (silica gel or activated alumina; zeolite X; exchanged zeolite), etc.

The advantage of using multilayers lies in other methods such as VSA O2, VSA CO2, PSA H2.

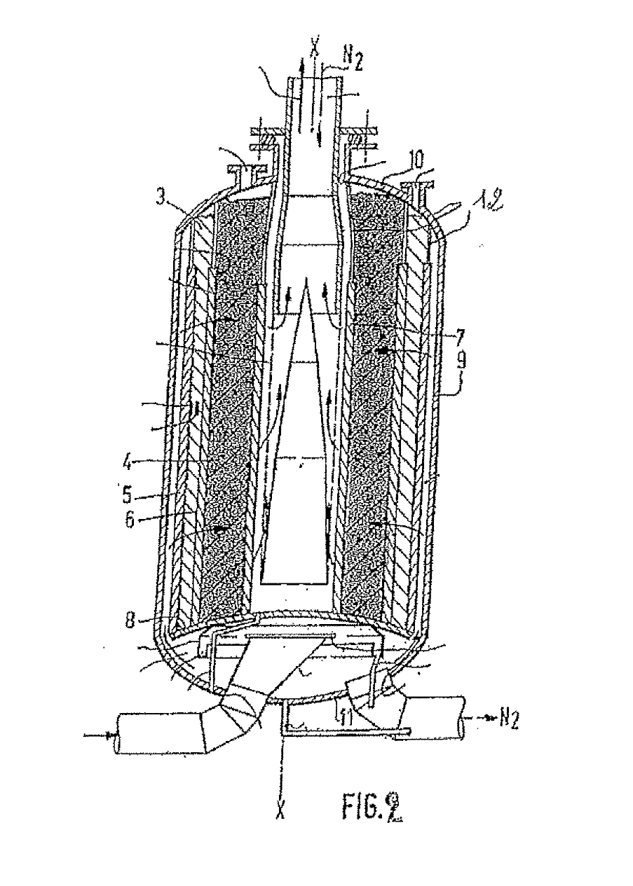

FIG. 2 represents, for example, a radial adsorber comprising 2 distinct adsorbent layers.

Generally, the adsorbents are held in place between perforated gratings. “Perforated grating” should be understood to mean a system permeable to gas, impermeable to the adsorbent particles and having sufficient mechanical characteristics to ensure reliable operation over several years. Such a grating may consist of a number of elements, for example a grating 6 or 8 mm thick with wide openings onto which is pressed a metal fabric with openings of less than a millimeter. The grating closest to the central axis is called “internal grating” and the grating closest to the external wall of the adsorber is called “external grating”. Depending on the number of different adsorbents used, intermediate gratings may be added. In practice, if N is the number of adsorbent layers, N−1 intermediate gratings must be used, giving a total of N+1 gratings.

These gratings, as already described, are permeable to gas and because of this comprise numerous perforations. Depending on the application and the stresses generated by the temperature or pressure effects, said gratings can be deliberately given longitudinally—or radially —increased elasticity. The document U.S. Pat. No. 4,541,851 gives examples of perforated plates having different elasticities depending on the arrangement of the perforations.

The invention relates more particularly to the construction of said radial adsorbers.

To simplify the description, it will be limited to the main constituent elements of such a radial adsorber, namely, in our example of FIG. 2:3 perforated gratings (5, 6, 7), their bottom base (8), the connecting pieces between the gratings and an end plate (12), 2 end plates (10 and 11) and the external shell (9). The system makes it possible to keep the adsorbents forming the cylindrical beds (3) and (4) in place.

The connecting pieces (12) may be of different shapes and dimensions depending on the precise technology retained for the adsorbers. They may, for example, comprise detachable hatches providing access to spaces between gratings or to the space between outer grating and shell. In other designs, these are only parts used to allow gratings to be fixed with their ends. They are generally designed to avoid preferential pathways for the gas in the top part.

Other elements—as, for example, a filter in the central annular space—are not mentioned in the description of the construction procedures. This does not alter the principles that will now be described and that in some way constitute the principle of the invention.

At the construction level, each of the gratings consists of a perforated plate providing mechanical strength, wound in a cylinder and equipped with a metal fabric whose openings are adequately selected to keep the adsorbent particles in place.

These gratings are produced horizontally using suitable equipment that conventionally exists in boiler-making firms (drilling machines, banding machines, welding machines, turning gear, travelling overhead cranes, gantry cranes, etc.). The metallic fabric is pressed onto the gratings and fixed to the latter by suitable systems (rods, washers, nuts, staples, etc.). For each of the gratings, the face to which the metallic fabric is applied is normally chosen so that the adsorbent applies it to the grating during filling or during normal operation.

The shell is also manufactured horizontally from metallic plates, generally made of carbon steel or sometimes of stainless steel.

The end plates are also equipped with their openings and flanges and prepared to be fixed to the shell.

The next step consists in threading then successively assembling the various gratings and the shell. The system is made solid by virtue of the base (8), at least one end plate (10, 11) and, where appropriate, the connecting pieces (12).

Threading and assembly are conventionally done “vertically”, that is to say that the various gratings are attached to a lifting system (crane, travelling overhead crane, gantry crane) by one of their ends so that their axis is vertical.

A number of mounting procedures are possible depending on the type of radial adsorber, its dimensions, the respective weights of the various equipment items, the checks to be carried out after assembly (weld radiography for example), the construction codes.

The two main variants of vertical mounting consist in assembling the various perforated gratings either on their base 8, or on an end plate 10 or 11 by using, if necessary, the connecting pieces 12. “Connecting piece” will be used to denote the piece to which the gratings will be fixed first, whether it is the bottom base 8 or one of the end plates of the adsorber 10, 11.

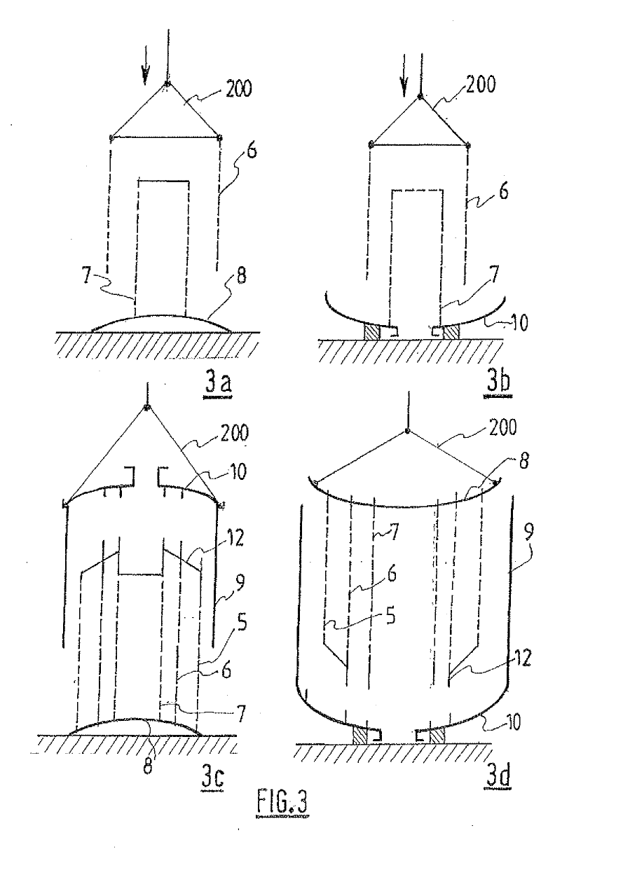

FIG. 3a illustrates the fitting of the intermediate grating 6 when the internal grating 7 has already been fixed to the base 8. The intermediate grating is maneuvered using a travelling overhead crane represented by its slings 200.

FIG. 3b shows the fitting of the intermediate grating in the case where the assembly of the gratings is done by using an end plate of the adsorber 10. The travelling overhead crane, the crane or the gantry crane used to maneuver the grating is symbolized by the slings 200.

It can be seen that with such a mounting procedure, the concentric positioning of the various gratings is relatively easy.

The fitting of the shell is usually done by using the same lifting means.

FIG. 3c shows the fitting of the shell 9 already fitted with its top end plate 10 which is lowered concentrically to the 3 gratings 5, 6, 7 fixed to their bottom base (8).

FIG. 3d shows a variant in which it is the set of perforated gratings fixed to their base which is lowered into the shell fitted with its top end plate 10. Connecting pieces 12 used to fix gratings and end plate together have been represented in FIGS. 3c and 3d.

This way, it is possible to conceive of a number of different procedures for assembling the gratings, the shell and at least one end plate. Their common point is that the various perforated gratings and usually the shell are maneuvered vertically by being fixed by one of their ends to a lifting means (travelling overhead crane, crane, gantry crane, etc.).

The finishing of the adsorber and in particular the fitting and the fixing of the last end plate can be done by keeping the gratings-shell assembly vertical or by “laying down” this assembly horizontally and then finishing the assembly.

Generally, the finishing of the adsorber (fitting of the accessories, sandblasting, painting, etc.) is done when it is in the horizontal position, that is to say with its long axis parallel to the ground.

The manufacture of radial adsorbers using these procedures does not in principle pose any particular problem but it is necessary for the construction workshop to have or be able to use the lifting means 200 accordingly, possibly even to have ditches to limit the height required.

In practice, for gratings 15 meters high (or long depending on the position relative to the ground), a travelling overhead crane (or a crane) of approximately 40 meters is required. It is in fact necessary to be able to pass the second grating to be fitted over the internal grating once the latter is fixed to the base 8 or to the top 10 or bottom 11 end plate. The same applies for the various gratings and possibly the shell.

Each additional meter of grating height requires the lifting means to be raised by two meters because of the vertical threading.

It is technically difficult to manufacture gratings in several pieces, at least two, to then weld them or more generally fix them. In practice, these gratings must hold adsorbents of small diameter in place and the slightest play would provoke a flow of the particles towards the internal or external spaces, creating a major problem. This does, however, remain a possibility, in particular in the previously mentioned case where the adsorber is separated into several volumes (centrifugal then centripetal circulations for example).

The external shell, may, for problems of weight, be threaded more easily in sections welded to one another.

As a variant, the system formed by the perforated gratings and the top end plate may be placed horizontally after it has been manufactured vertically and the shell can be threaded horizontally.

Spreaders, centering pieces, supports, and other such items may be fitted temporarily or definitively to facilitate handling.

The description given of a vertical threading of the perforated gratings, is only one example corresponding to a particular radial adsorber model. The general principle is that the fitting motion of the perforated gratings takes place from top to bottom parallel to the action of gravity. With maneuvers of this kind, the gratings suffer little or no deformation.

The necessary height of the workshops for threading the gratings concentrically relative to one another limits the number of those who can handle the construction of large adsorbers.

The workshop that has sufficient capabilities may be relatively distant from the site where the adsorbers have to be installed. Transport from the workshop to the site may itself be problematic. Overall the distance from the workshops and the lack of competition leads to excessive costs for these radial adsorbers.

It is also possible to handle the final manufacturing of the adsorber on site, the various gratings and the shell having been manufactured in the workshop. This means immobilizing one or more exceptional lifting means (cranes) for a fairly long period and leads to dependence on atmospheric conditions. It can be seen that this type of final vertical assembly on site cannot be made generally available and that it may be very costly.

Starting from that, one problem that arises is how to provide an improved method of assembling radial adsorbers, a method that would in particular be applicable to large dimension gratings, for example more than 10 m.

In the following explanation of the invention, the various elements of a radial adsorber are referenced according to the reference numbers of FIG. 2.

One solution of the invention is a method of assembling at least one radial adsorber comprising at least two concentric perforated gratings, a top end plate 10, a bottom end plate 11, an assembly piece, which is a bottom base 8 or the bottom end plate 11 of said adsorber, and a cylindrical shell 9 with the same axis as said gratings, characterized in that said perforated gratings are assembled concentrically horizontally.

“Horizontal” means parallel to the ground.

Another subject of the invention is an assembly comprising a device D consisting of a support 100 and at least one plinth 101 firmly attached to the support 100, and at least one lifting means 201, characterized in that;
the plinth 101 is such that an assembly piece of a radial adsorber can be fixed to said plinth,
the lifting means is capable of positioning the gratings of the radial adsorber, in the horizontal position, against the assembly piece, fixed to the plinth 101 so as to facilitate the horizontal welding of the grating to the base, and in that
the support 100 is capable of holding the grating cantilevered horizontally when the grating is welded to said bottom base.

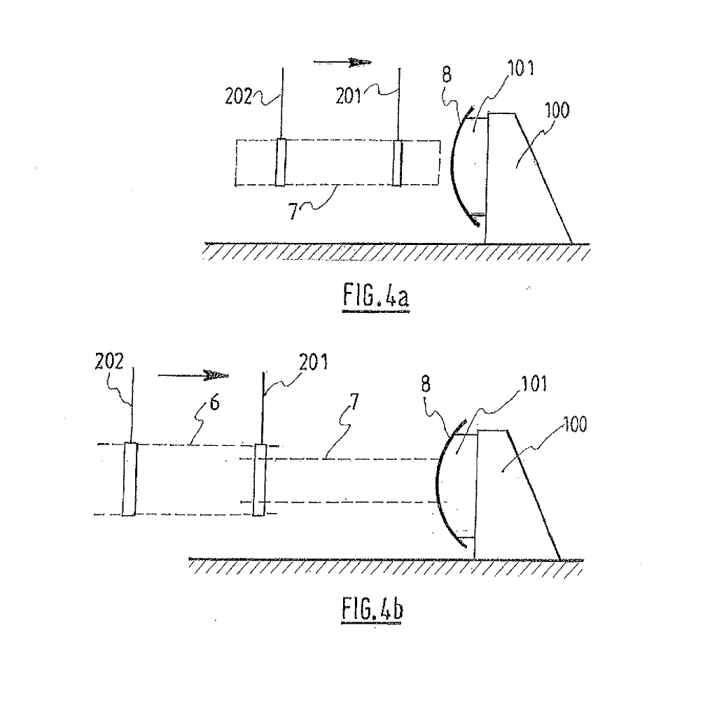

The assembly according to the invention is represented in FIGS. 4a and 4b.

Preferably, the plinth 101 securely attached to the support 100 revolves about its central axis.

Preferably again, said device D comprises two plinths 101 positioned on either side of the support 100.

The lifting means 201 is preferably a travelling overhead crane.

The assembly piece is a bottom base 8, a bottom end plate 11 or a top end plate 10 of the radial adsorber. It is also possible to consider having for the assembly piece a top end plate 10 to which the perforated gratings of the radial adsorber will be fixed.

The support 100 is of a shape and weight such that it can support the loads that are fixed to it. The support may itself be fixed to the ground by suitable means.

The term “plinth” will be used to define the plate, possibly in disk form, and more generally the system to which the assembly piece is fixed.

This assembly piece, as already indicated, will usually be either the base supporting the gratings, or the bottom end plate 11 of the adsorber.

It will be noted that the support (100) and the plinth (101) may be one and the same piece providing the two functions that are, on the one hand, “fixing” to the assembly piece, and on the other hand “holding” said adsorber in the horizontal position.

The assembly according to the invention may comprise, preferably, when used for gratings higher than approximately 10 to 15 m:
a mobile support 50 capable of supporting a grating of a radial adsorber supported at one end by the device D; and
a mechanical means 60 capable of being inserted into the internal space of a grating of a radial adsorber in the horizontal position and of supporting the latter.

When the radial adsorber has for the assembly part a bottom base 8 the assembly method according to the invention, in which an assembly according to the invention is used, preferably comprises the following steps:
a) the gratings of the radial adsorber are positioned concentrically by means of the lifting means 201 in the horizontal position against the bottom base 8 and welded horizontally to said base to form a welded “bottom base-gratings” assembly held cantilevered horizontally by the device D; and
b1) an external shell 9 is positioned around the gratings welded in the step a), then the bottom 11 and top 10 end plates are welded to the shell 9; or
b2) an external shell 9, to which the top end plate 10 has previously been welded, is positioned around the gratings welded in the step a), then the bottom end plate 11 is welded to the shell.

When the radial adsorber has for the assembly piece the bottom end plate 11, the assembly method according to the invention, in which an assembly according to the invention is used, preferably comprises the following steps:
a) the gratings of the radial adsorber are positioned concentrically by means of the lifting means 201 in the horizontal position against the bottom end plate 11 and welded horizontally to said end plate to form a welded “bottom end plate 11-gratings” assembly held cantilevered horizontally by the device D; and
b1) an external shell 9 is positioned around the gratings welded in the step a), then the top end plate 10 is welded to the shell 9; or
b2) an external shell 9, to which the top end plate 10 has previously been welded, is positioned around the gratings welded in the step a).

When the radial adsorber has for the assembly piece a top end plate 10, the assembly method according to the invention, in which an assembly according to the invention is used, preferably comprises the following steps:
a) the gratings of the radial adsorber are positioned concentrically by means of the lifting means 201 in the horizontal position against the top end plate 10 and welded horizontally to said end plate to form a welded “top end plate 10-gratings” assembly held cantilevered horizontally by the device D; and
b1) an external shell 9 is positioned around the gratings welded in the step a), then the bottom end plate 11 is welded to the shell 9; or
b2) an external shell 9, to which the bottom end plate 11 has previously been welded, is positioned around the gratings welded in the step a).

Preferably, when the radial adsorber has for the assembly piece a top end plate 10, the gratings are fixed to a bottom base 8 between the steps a) and b1) or b2).

In these three methods, the expression “a shell is positioned” should be understood to mean either that the shell is threaded around the gratings, or that the gratings are inserted inside the shell.

The above three methods may comprise one or more of the following characteristics:
a device D is used comprising two plinths 101 positioned on either side of the support 100 and in that two radial adsorbers are constructed in parallel;
in the step a), the gratings of the adsorber are threaded onto and welded in succession, concentrically, to the assembly piece, beginning with the smallest diameter grating.

FIGS. 4a and 4b illustrate the assembly method, taking as an example the method in which the assembly piece is the bottom base 8. FIG. 4a shows the positioning of the first grating 7 (internal grating) by means of two travelling overhead cranes 201 and 202. Once fixed to the bottom base 8, the first grating 7 is held in balance as shown in FIG. 4b. In practice, the support 100 has a sufficient weight or is adequately secured to the ground to keep the grating in balance without any external support or help.

FIG. 4b also shows how the second grating 6 is threaded concentrically onto the first.

The rotation of the plinth causing the rotation of the base and of the grating makes it possible to perform the welding optimally, that is to say, without having to move the welding appliance around the grating (or the shell).

The same method is used with the various gratings.

The support must be capable of holding all the perforated gratings cantilevered. Depending on the size of the adsorber, this represents tens to hundreds of tons. This balance may if necessary be obtained by creating a lever effect on the side opposite to the adsorber. It may be a counterweight or a fixing in the ground.

The assembly of gratings and the bottom base 8 are then inserted into the external shell 9 to which the end plate 10 will have previously been welded. In order to do this, as represented in FIG. 5, it is possible to use both a travelling overhead crane 200 and a mobile support carriage 30 controlled by a control box 31. Since the shell is smooth, the carriage 30 may be displaced horizontally without any problems. The shell itself is supported by turning cradles 32. After fixing the gratings to the shell and chocking, it is then possible to rotate the assembly. This facilitates the final operations.

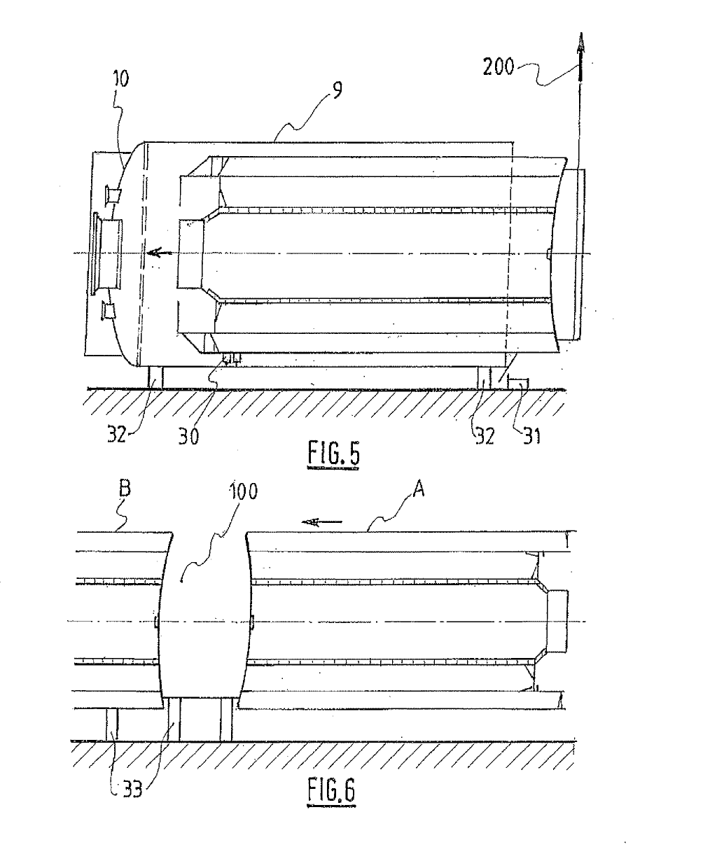

A mounting procedure may make it possible to balance the weights involved and to limit the cantilever as can be seen FIG. 6. Two adsorbers A and B, fixed head-to-tail on a common support 40, are constructed in parallel, that is to say that the internal grating of the adsorber B for example is fixed, followed by the internal grating of the adsorber A. The system is then naturally in balance. The procedure continues in this way with the next two identical gratings fixed on one side and then the other. And so on. In this way, the cantilever is always only of one grating. With a central support of given characteristic (weight, surface area on the ground, fixing to the ground, etc.), it is then possible to construct much larger adsorbers. The production principle is represented in FIG. 6. The third grating of the adsorber A is brought toward the common support to then be welded thereto while this grating has already been fitted on the adsorber B side.

It has become apparent that these horizontal threading systems, despite everything, presented limitations when the size of the adsorbers becomes much greater.

This limitation appears more specifically when the height of the perforated gratings exceeds a certain value, generally 10 to 15 m depending on the characteristics of said gratings (diameter, perforation rate, etc.) in the case of radial adsorbers intended for air purification applications. In practice, because of their perforation, the perforated gratings have an “inertia” that is less than that of a non-perforated cylinder, which provokes a relatively significant deviation toward the ground (deflection) of the free end of the gratings when they are fixed horizontally to their support.

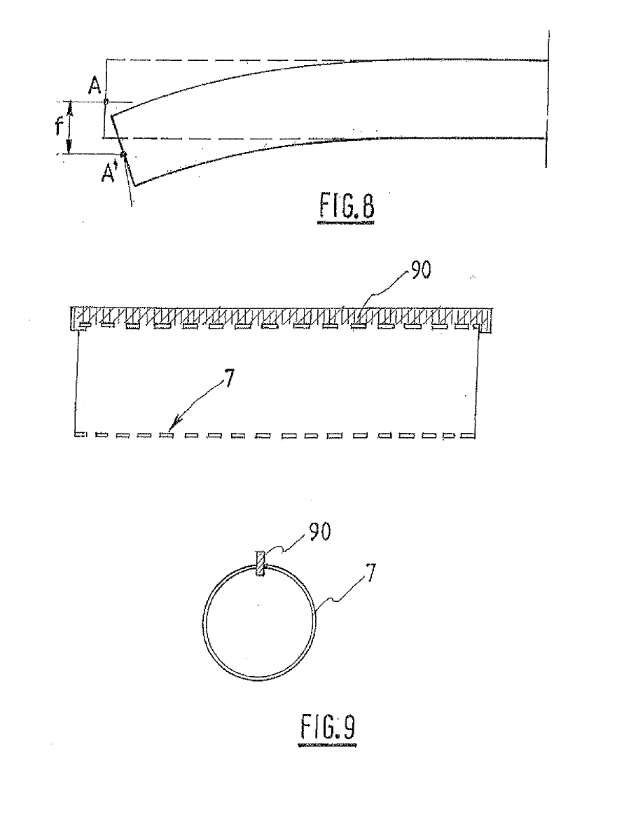

FIG. 8 illustrates this point and defines the deflection (f) as used hereinafter in the text. The deflection is the vertical distance between, on the one hand, the center of the free end of a grating, assumed parallel to the ground over its entire length (that is to say, not subject to any deformation), and on the other hand, the center of the free end of this same grating subject to a deviation under the effect of its weight.

“Free end” should be understood to mean the end of the grating that is not fixed to the bottom base 8 (or more generally to the assembly piece) and therefore that is not directly supported by the support 100.

With the free end of the grating remaining essentially circular, a deviation of the same order of magnitude can also be obtained by taking as a reference the limit point of the bottom generatrix (A and A′ in FIG. 8).

The longer the grating, the greater the deflection (f). The deflection varies as a first approximation, like the length, to the power 4.

The expression “natural deflection” will be used hereinafter to mean the deflection of a grating fixed to its assembly piece in the absence of any supporting system.

This deformation eliminates the symmetry around the horizontal axis and may rapidly prevent the threading of the next grating. In practice, to limit the load losses through the adsorber, the thicknesses retained for the adsorbent beds are small, which means that the successive gratings have relatively similar diameters. Geometrically, it can be seen that the deflection of the internal grating must be less than the difference between the radii of the two gratings.

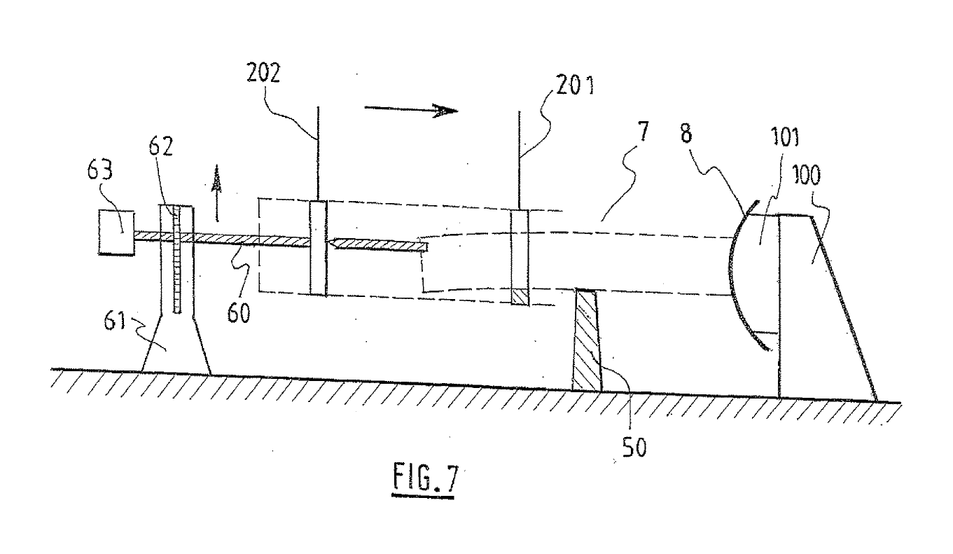

In the following method, reference is made to the elements of a radial adsorber represented in FIG. 2, and to the elements of a device represented in FIG. 7.

One solution of the invention is a method of assembling at least one radial adsorber comprising at least two concentric perforated gratings, a top end plate 10, a bottom end plate 11, a bottom base 8 for the assembly piece, and a cylindrical shell 9 with the same axis as said gratings, in which a device according to the invention is used that has a mobile support 50 and a mechanical means 60, and comprising the following steps:
a) the smaller diameter grating of the radial adsorber is positioned by means of the lifting means 201 in the horizontal position against the bottom base 8 and welded horizontally to said base, to form a welded “bottom base 8-gratings” assembly held cantilevered horizontally by the device D,
b) the smaller diameter grating welded in the step a) is held at its mid-length by a mobile support 50 and the larger diameter grating is threaded horizontally, over a non-zero length L, around the internal grating,
c) the mechanical means 60 is inserted at least partly into the internal space of the smaller diameter grating so as to hold the latter in the position from which it benefits when it is supported by the mobile support and said mobile support is removed,
d) the larger diameter grating is threaded horizontally as far as the bottom base 8 and welded to the latter;
e) the remaining gratings of the radial adsorber are assembled concentrically around the larger diameter grating; and
f1) an external shell 9 is positioned around the welded gratings, then the bottom 11 and top 10 end plates are welded to the shell 9; or
f2) an external shell 9, to which the top end plate 10 has previously been welded, is positioned around the welded gratings, then the bottom end plate 11 is welded to the shell.

Preferably, in the step e) for concentrically assembling the remaining gratings, the steps a) to d) are reiterated with the remaining gratings of the radial adsorber, each time assuming that the smaller diameter grating is the last grating welded to the bottom base 8.

A variant of this method is a method of assembling at least one radial adsorber comprising at least two concentric perforated gratings, a top end plate 10, a bottom end plate 11 for the assembly piece, and a cylindrical shell 9 with the same axis as said gratings, in which a device according to the invention is used that has a mobile support 50 and a mechanical means 60, and comprising the following steps:
a) the smaller diameter grating of the radial adsorber is positioned by means of the lifting means 201 in the horizontal position against the bottom end plate 11 and welded horizontally to said end plate, to form a welded “bottom end plate 11-gratings” assembly held cantilevered horizontally by the device D,
b) the smaller diameter grating welded in the step a) is held at its mid-length by a mobile support 50 and the larger diameter grating is threaded horizontally, over a non-zero length L, around the internal grating,
c) the mechanical means 60 is inserted at least partly into the internal space of the smaller diameter grating so as to hold the latter in the position from which it benefits when it is supported by the mobile support and said mobile support is removed,
d) the larger diameter grating is threaded horizontally as far as the bottom end plate 11 and welded to the latter;
e) the remaining gratings of the radial adsorber are assembled concentrically around the larger diameter grating; and
f1) an external shell 9 is positioned around the welded gratings, then the top end plate 10 is welded to the shell 9; or
f2) an external shell 9, to which the top end plate 10 has previously been welded, is positioned around the welded gratings.

Preferably, in the step e), to concentrically assemble the remaining gratings, the steps a) to d) are reiterated with the remaining gratings of the radial adsorber, each time assuming that the smaller diameter grating is the last grating welded to the bottom end plate 11.

Another variant of this method is a method of assembling at least one radial adsorber comprising at least two concentric perforated gratings, a bottom end plate (11), a top end plate (10) for the assembly piece, and a cylindrical shell 9 with the same axis as said gratings, in which a device according to the invention is used that has a mobile support 50 and a mechanical means 60, and comprising the following steps:
a) the smaller diameter grating of the radial adsorber is positioned by means of the lifting means 201 in the horizontal position against the top end plate 10 and welded horizontally to said end plate, to form a welded “top end plate 10-gratings” assembly held cantilevered horizontally by the device D,
b) the smaller diameter grating welded in the step a) is held at its mid-length by a mobile support 50 and the larger diameter grating is threaded horizontally, over a non-zero length L, around the internal grating,
c) the mechanical means 60 is inserted at least partly into the internal space of the smaller diameter grating so as to hold the latter in the position from which it benefits when it is supported by the mobile support and said mobile support is removed,
d) the larger diameter grating is threaded horizontally as far as the top end plate 10 and welded to the latter;
e) the remaining gratings of the radial adsorber are assembled concentrically around the larger diameter grating; and
f1) an external shell 9 is positioned around the welded gratings, then the bottom end plate 11 is welded to the shell 9; or
f2) an external shell 9, to which the bottom end plate 11 has previously been welded, is positioned around the welded gratings.

Preferably, in the step e), to concentrically assemble the remaining gratings, the steps a) to d) are reiterated with the remaining gratings of the radial adsorber, each time assuming that the smaller diameter grating is the last grating welded to the top end plate 10.

Preferably, when the radial adsorber has for the assembly piece a top end plate 10, the gratings are fixed to a bottom base 8 between the steps e) and f1) or f2).

This method can be used to horizontally construct radial adsorbers comprising perforated gratings of a height ranging up to approximately 12 to 25 m (depending on the characteristics of said gratings: diameter, rate and type of perforations, etc.).

The bottom bases to which the gratings can be fixed generally have diameters ranging from 2 to 6 meters. Approximately the same applies to the end plates of the adsorber (2 to 7 meters). These dimensions are often fixed by the transportation constraints. From the assembly viewpoint, there is nothing to prevent having larger diameters, subject to the availability of the appropriate equipment (travelling overhead crane, device D).

The description given hereinabove defines the principles of the assembly that are the subject of the invention. Variants are possible without in any way changing the characteristics of the horizontal assembly. As an example, the mobile support which is used in the case of very long and/or very flexible gratings may be placed not in the middle of the latter but, for example, closer to the supported end so as to allow just the threading of the larger diameter grating. The fitting of the mechanical means 60 will then be simplified (shorter distance to the grating to be supported).

Depending on the case, the method according to the invention for constructing at least one radial adsorber comprising concentric perforated gratings may include at least one of the following characteristics:
a stiffener 90 is fixed to at least one grating during at least one part of the construction so as to limit the flexibility of the grating,
throughout the threading of the gratings, the deflection of each of said gratings is less than 20 cm, preferably less than 10 cm.

FIG. 7 illustrates the method of assembling at least one radial adsorber comprising gratings taller than 12 m and that pose a threading problem because of the natural deflection resulting therefrom, taking as an example the method in which the assembly piece is the bottom base 8. Firstly, the internal grating 7, after having been fixed to the bottom base 8, is held at approximately its mid-length by a mobile support 50.

Because of the support, the deflection f at the free end is much smaller than the deflection that there would be without support. This deflection may be reduced, as an example, to a value of around ten centimeters—or less—whereas without support, it could reach and exceed a meter. Secondly, the next grating 6 is threaded around the first grating using the mobile lifting means 201, 202 (preferably travelling overhead crane) until the end of the grating to be fixed to the common support is close to the support of the internal grating. While the gratings are in this position, an “arm” 60 is threaded into the free end (opposite the plinth 100 and the bottom base 8) of the grating that is to be threaded. This arm is maneuvered so as to come into contact with the free end of the internal grating. This arm is securely attached to its support 61 via a rack 62. A counter-weight 63 can be used if necessary to balance the force to be supplied at the end of the arm to hold in place, or even straighten, the internal grating 7. FIG. 7 illustrates the moment when the arm supports the internal grating and when it is then possible to remove the mobile support 50 without risk of the internal grating, because of its natural deflection, bearing on the external grating, so preventing the fitting of said gratings from continuing.

With the larger diameter grating being threaded, it is then possible to fit the supports to hold the concentricity of the two gratings.

If necessary, the procedure continues in this way with the subsequent grating or gratings.

With the system formed by the gratings and the bottom base 8 having been produced, the threading of the shell can then be performed according to one of the procedures already described.

In this first variant, a horizontal construction is allowed by supporting at least one of the gratings by a bearing means (support, arm).

A “stiffener system” may be temporarily installed during the construction on one or more gratings, which then limits the deflection. In principle, this is a piece of equipment fixed to the interior or the exterior of the grating, longitudinally, on one or more generatrices. This device rigidifies the grating by limiting the flexibility caused partly by the perforations: it blocks the basic cylindrical geometry by limiting elongation and/or compression.

Such a system is diagrammatically represented in FIG. 9. The stiffener 90 is fixed to a generatrix of the grating 7. Preferably, it will be installed on the face of the grating on which there is no metallic fabric, in order not to risk damaging the latter. It consists of a rigid piece approximately of the length of the grating to be supported and securely attached to the latter by an appropriate fixing system.

These stiffeners can be removed after the support has been fitted to hold the concentricity of the gratings.

They may possibly be left in place to increase the rigidity of the gratings during the operation of the adsorber.

Finally, other subjects of the present invention are:
a radial adsorber constructed according to a method according to the invention. This adsorber preferably has a shell diameter of 2 to 7 m, preferably of 3 to 6 m and/or a grating height of 3 to 25 m, preferably of 5 to 20 m;
a method of separating or purifying a gas that uses an adsorber according to the invention. This method may be a method of purifying air of at least one of the impurities that include H₂O, CO₂, NOx, hydrocarbons, etc., a method of producing oxygen by adsorption, or a method of deballasting CO₂ from various gases.

1. to 21. (canceled)

22. An assembly comprising a device D consisting of a support (100) and at least one plinth (101) firmly attached to the support (100), and at least one lifting means (201), wherein:
the plinth (101) is such that an assembly piece of a radial adsorber can be fixed to said plinth,
the lifting means is capable of positioning the gratings of the radial adsorber, in the horizontal position, against the assembly piece, fixed to the plinth (101) so as to facilitate the horizontal welding of the grating to the base, and in that
the support (100) is capable of holding the grating cantilevered horizontally when the grating is welded to said bottom base.

23. The assembly of claim 22, wherein the plinth (101) securely attached to the support revolves about a central axis.

24. The assembly of claim 22, wherein said device D comprises two plinths (101) positioned on either side of the support (100).

25. The assembly of claim 22, wherein the assembly piece is a bottom base (8), bottom end plate (11) or a top end plate (10) of the radial adsorber.

26. The assembly of claim 22, wherein said assembly comprises:
- a mobile support (50) capable of supporting a grating of a radial adsorber supported at one end by the device D and of a height greater than 10 m;
and a mechanical means (60) capable of being inserted into the internal space of a grating of a radial adsorber in the horizontal position and of supporting the latter.

27. A method of assembling at least one radial adsorber comprising at least two concentric perforated gratings, a top end plate (10), a bottom end plate (11) and a cylindrical shell (9) with the same axis as said gratings, wherein said perforated gratings are assembled concentrically horizontally.

28. The method of claim 27, wherein at least one radial adsorber comprising, for the assembly piece, a bottom base (8), in which an assembly comprising a device D consisting of a support (100) and at least one plinth (101) firmly attached to the support (100), and at least one lifting means (201), wherein the plinth (101) is such that an assembly piece of a radial adsorber can be fixed to said plinth, the lifting means is capable of positioning the gratings of the radial adsorber, in the horizontal position, against the assembly piece, fixed to the plinth (101) so as to facilitate the horizontal welding of the grating to the base, and in that the support (100) is capable of holding the grating cantilevered horizontally when the grating is welded to said bottom base is utilized, the method comprising the following steps:
a) the gratings of the radial adsorber are positioned concentrically by means of the lifting means (201) in the horizontal position against the bottom base (8) and welded horizontally to said base to form a welded “bottom base-gratings” assembly held cantilevered horizontally by the device D; and
b1) an external shell (9) is positioned around the gratings welded in the step a), then the bottom (11) and top (10) end plates are welded to the shell (9); or
b2) an external shell (9), to which the top end plate (10) has previously been welded, is positioned around the gratings welded in the step a), then the bottom end plate (11) is welded to the shell.

29. The method of claim 27, wherein at least one radial adsorber comprising, for the assembly piece, the bottom end plate (11), in which an assembly comprising a device D consisting of a support (100) and at least one plinth (101) firmly attached to the support (100), and at least one lifting means (201), wherein the plinth (101) is such that an assembly piece of a radial adsorber can be fixed to said plinth, the lifting means is capable of positioning the gratings of the radial adsorber, in the horizontal position, against the assembly piece, fixed to the plinth (101) so as to facilitate the horizontal welding of the grating to the base, and in that the support (100) is capable of holding the grating cantilevered horizontally when the grating is welded to said bottom base is utilized, the method comprising the following steps:
a) the gratings of the radial adsorber are positioned concentrically by means of the lifting means (201) in the horizontal position against the bottom end plate (11) and welded horizontally to said end plate to form a welded “bottom end plate (11)-gratings” assembly held cantilevered horizontally by the device D; and
b1) an external shell (9) is positioned around the gratings welded in the step a), then the top end plate (10) is welded to the shell (9); or
b2) an external shell (9), to which the top end plate (10) has previously been welded, is positioned around the gratings welded in the step a).

30. The method of claim 27, wherein at least one radial adsorber comprising, for the assembly piece, the top end plate (10), in which an assembly comprising a device D consisting of a support (100) and at least one plinth (101) firmly attached to the support (100), and at least one lifting means (201), wherein the plinth (101) is such that an assembly piece of a radial adsorber can be fixed to said plinth, the lifting means is capable of positioning the gratings of the radial adsorber, in the horizontal position, against the assembly piece, fixed to the plinth (101) so as to facilitate the horizontal welding of the grating to the base, and in that the support (100) is capable of holding the grating cantilevered horizontally when the grating is welded to said bottom base is utilized, the method comprising the following steps:
a) the gratings of the radial adsorber are positioned concentrically by means of the lifting means (201) in the horizontal position against the top end plate (10) and welded horizontally to said end plate to form a welded “top end plate (10)-gratings” assembly held cantilevered horizontally by the device D; and
b1) an external shell (9) is positioned around the gratings welded in the step a), then the bottom end plate (11) is welded to the shell (9); or
b2) an external shell (9), to which the bottom end plate (11) has previously been welded, is positioned around the gratings welded in the step a).

31. The method of claim 30, wherein, between the steps a) and b1) or b2), the gratings are fixed to a bottom base (8).

32. The method of claim 28, wherein a device D is used comprising two plinths (101) positioned on either side of the support (100) and in that two radial adsorbers are constructed in parallel.

33. The method of claim 29, wherein a device D is used comprising two plinths (101) positioned on either side of the support (100) and in that two radial adsorbers are constructed in parallel.

34. The method of claim 30, wherein a device D is used comprising two plinths (101) positioned on either side of the support (100) and in that two radial adsorbers are constructed in parallel.

35. The method of claim 28, wherein, in the step a), the gratings of the adsorber are threaded onto and welded in succession, concentrically, to the assembly piece, beginning with the smallest diameter grating.

36. The method of claim 29, wherein, in the step a), the gratings of the adsorber are threaded onto and welded in succession, concentrically, to the assembly piece, beginning with the smallest diameter grating.

37. The method of claim 30, wherein, in the step a), the gratings of the adsorber are threaded onto and welded in succession, concentrically, to the assembly piece, beginning with the smallest diameter grating.

38. A method of assembling at least one radial adsorber comprising at least two concentric perforated gratings, a top end plate (10), a bottom end plate (11), a bottom base (8) for the assembly piece, and a cylindrical shell (9) with the same axis as said gratings, in which an assembly comprising a device D consisting of a support (100) and at least one plinth (101) firmly attached to the support (100), at least one lifting means (201), a mobile support (50) capable of supporting a grating of a radial adsorber supported at one end by the device D and of a height greater than 10 m, and a mechanical means (60) capable of being inserted into the internal space of a grating of a radial adsorber in the horizontal position and of supporting the latter, wherein the plinth (101) is such that an assembly piece of a radial adsorber can be fixed to said plinth, the lifting means is capable of positioning the gratings of the radial adsorber, in the horizontal position, against the assembly piece, fixed to the plinth (101) so as to facilitate the horizontal welding of the grating to the base, and in that the support (100) is capable of holding the grating cantilevered horizontally when the grating is welded to said bottom base, is utilized, the method comprising the following steps:
a) the smaller diameter grating of the radial adsorber is positioned by means of the lifting means (201) in the horizontal position against the bottom base (8) and welded horizontally to said base, to form a welded “bottom base (8)-gratings” assembly held cantilevered horizontally by the device D,
b) the smaller diameter grating welded in the step a) is held at its mid-length by a mobile support (50) and the larger diameter grating is threaded horizontally, over a non-zero length L, around the internal grating,
c) the mechanical means (60) is inserted at least partly into the internal space of the smaller diameter grating so as to hold the latter in the position from which it benefits when it is supported by the mobile support and said mobile support is removed,
d) the larger diameter grating is threaded horizontally as far as the bottom base (8) and welded to the latter;
e) the remaining gratings of the radial adsorber are assembled concentrically around the larger diameter grating; and
f1) an external shell (9) is positioned around the welded gratings, then the bottom (11) and top (10) end plates are welded to the shell (9); or
f2) an external shell (9), to which the top end plate (10) has previously been welded, is positioned around the welded gratings, then the bottom end plate (11) is welded to the shell.

39. The method of claim 38, wherein, in the step e), to concentrically assemble the remaining gratings, the steps a) to d) are reiterated with the remaining gratings of the radial adsorber, each time assuming that the smaller diameter grating is the last grating welded to the bottom base (8).

40. A method of assembling at least one radial adsorber comprising at least two concentric perforated gratings, a top end plate (10), a bottom end plate (11) for the assembly piece, and a cylindrical shell (9) with the same axis as said gratings, in which an assembly comprising a device D consisting of a support (100) and at least one plinth (101) firmly attached to the support (100), at least one lifting means (201), a mobile support (50) capable of supporting a grating of a radial adsorber supported at one end by the device D and of a height greater than 10 m, and a mechanical means (60) capable of being inserted into the internal space of a grating of a radial adsorber in the horizontal position and of supporting the latter, wherein the plinth (101) is such that an assembly piece of a radial adsorber can be fixed to said plinth, the lifting means is capable of positioning the gratings of the radial adsorber, in the horizontal position, against the assembly piece, fixed to the plinth (101) so as to facilitate the horizontal welding of the grating to the base, and in that the support (100) is capable of holding the grating cantilevered horizontally when the grating is welded to said bottom base, is utilized, the method comprising the following steps:
a) the smaller diameter grating of the radial adsorber is positioned by means of the lifting means (201) in the horizontal position against the bottom end plate (11) and welded horizontally to said end plate, to form a welded “bottom end plate (11)-gratings” assembly held cantilevered horizontally by the device D,
b) the smaller diameter grating welded in the step a) is held at its mid-length by a mobile support (50) and the larger diameter grating is threaded horizontally, over a non-zero length L, around the internal grating,
c) the mechanical means (60) is inserted at least partly into the internal space of the smaller diameter grating so as to hold the latter in the position from which it benefits when it is supported by the mobile support and said mobile support is removed,
d) the larger diameter grating is threaded horizontally as far as the bottom end plate (11) and welded to the latter;
e) the remaining gratings of the radial adsorber are assembled concentrically around the larger diameter grating; and
f1) an external shell (9) is positioned around the welded gratings, then the top end plate (10) is welded to the shell (9); or
f2) an external shell (9), to which the top end plate (10) has previously been welded, is positioned around the welded gratings.

41. The method of claim 40, wherein, in the step e), to concentrically assemble the remaining gratings, the steps a) to d) are reiterated with the remaining gratings of the radial adsorber, each time assuming that the smaller diameter grating is the last grating welded to the bottom end plate (11).

42. A method of assembling at least one radial adsorber comprising at least two concentric perforated gratings, a bottom end plate (11), a top end plate (10) for the assembly piece, and a cylindrical shell (9) with the same axis as said gratings, in which an assembly comprising a device D consisting of a support (100) and at least one plinth (101) firmly attached to the support (100), at least one lifting means (201), a mobile support (50) capable of supporting a grating of a radial adsorber supported at one end by the device D and of a height greater than 10 m, and a mechanical means (60) capable of being inserted into the internal space of a grating of a radial adsorber in the horizontal position and of supporting the latter, wherein the plinth (101) is such that an assembly piece of a radial adsorber can be fixed to said plinth, the lifting means is capable of positioning the gratings of the radial adsorber, in the horizontal position, against the assembly piece, fixed to the plinth (101) so as to facilitate the horizontal welding of the grating to the base, and in that the support (100) is capable of holding the grating cantilevered horizontally when the grating is welded to said bottom base, is utilized, the method comprising the following steps:
a) the smaller diameter grating of the radial adsorber is positioned by means of the lifting means (201) in the horizontal position against the top end plate (10) and welded horizontally to said end plate, to form a welded “top end plate (10)-gratings” assembly held cantilevered horizontally by the device D,
b) the smaller diameter grating welded in the step a) is held at its mid-length by a mobile support (50) and the larger diameter grating is threaded horizontally, over a non-zero length L, around the internal grating,
c) the mechanical means (60) is inserted at least partly into the internal space of the smaller diameter grating so as to hold the latter in the position from which it benefits when it is supported by the mobile support and said mobile support is removed,
d) the larger diameter grating is threaded horizontally as far as the top end plate (10) and welded to the latter;
e) the remaining gratings of the radial adsorber are assembled concentrically around the larger diameter grating; and
f1) an external shell (9) is positioned around the welded gratings, then the bottom end plate (11) is welded to the shell (9); or
f2) an external shell (9), to which the bottom end plate (11) has previously been welded, is positioned around the welded gratings.

43. The method of claim 42, wherein, in the step e), to concentrically assemble the remaining gratings, the steps a) to d) are reiterated with the remaining gratings of the radial adsorber, each time assuming that the smaller diameter grating is the last grating welded to the top end plate (10).

44. The method of claim 38, wherein, between the steps e) and f1) or f2), the gratings are fixed to a bottom base (8).

45. The method of claim 39, wherein, between the steps e) and f1) or f2), the gratings are fixed to a bottom base (8).

46. The method of claim 27, wherein a stiffener (90) is fixed to at least one grating during at least one part of the construction so as to limit the flexibility of the grating.

47. The method of claim 32, wherein, throughout the threading of the gratings, the deflection of each of said gratings is less than 20 cm, preferably less than 10 cm.
